(19) United States
(12) Patent Application Publication
(10) Pub. No.: US 2012/0278403 A1
(43) Pub. Date: Nov. 1, 2012

(54) PRESENTING LINK INFORMATION NEAR LINKS WITHIN ELECTRONIC MESSAGES

(75) Inventors: Daniel Paul Costenaro, Bellevue, WA (US); Jedidiah Brown, Seattle, WA (US)

(73) Assignee: Microsoft Corporation, Redmond, WA (US)

(21) Appl. No.: 13/096,869

(22) Filed: Apr. 28, 2011

(51) Int. Cl. G06F 15/16

(52) U.S. Cl. 709/206

(57) ABSTRACT

Link information is presented near a link within an electronic message that describes activity information relating to the linked content. The link information may include many different type of information. For example, the link information may include editing information for the linked content (e.g. editors, editing time, number of edits), who has/has not reviewed the linked content, linked content information (e.g. summary, permissions, type of content, update times) and the like. The linked content may be a link to any type of content, such as word processing documents, spreadsheets, slides, websites and the like. Viewing the link information for the linked content provides a user with an indication of the activity regarding the linked content.

### BACKGROUND

Users routinely send links to documents and other content to users for viewing. Many times, a message thread will contain a number of links to various content. When the user accesses the message containing one or more links to documents or other content, they don't know how much reviewing, reading or editing activity has happened on the document or file.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Link information is presented near a link within an electronic message that describes activity information relating to the linked content. The link information may include many different type of information. For example, the link information may include editing information for the linked content (e.g. editors, editing time, number of edits), who has/has not reviewed the linked content, linked content information (e.g. summary, permissions, type of content, update times) and the like. The linked content may be a link to any type of content, such as word processing documents, spreadsheets, slides, websites and the like. Viewing the link information for the linked content provides a user with an indication of the activity regarding the linked content.

### BRIEF DESCRIPTION OF THE DRAWINGS

FIG. 1 illustrates an exemplary computing environment;

FIG. 2 shows a system for presenting link information near links within electronic messages;

FIG. 3 shows a display of an electronic message including a link within a body of an electronic message and corresponding link information;

FIG. 4 shows a display of an electronic message before and after a user action is performed to display link information for a link;

FIG. 5 shows exemplary link information that may be displayed near links within an electronic message;

FIG. 6 shows a display of an electronic message within a Web browser including a link to content and link information within a body of an electronic message; and

FIG. 7 shows an illustrative process for presenting link information near links within electronic messages.

### DETAILED DESCRIPTION

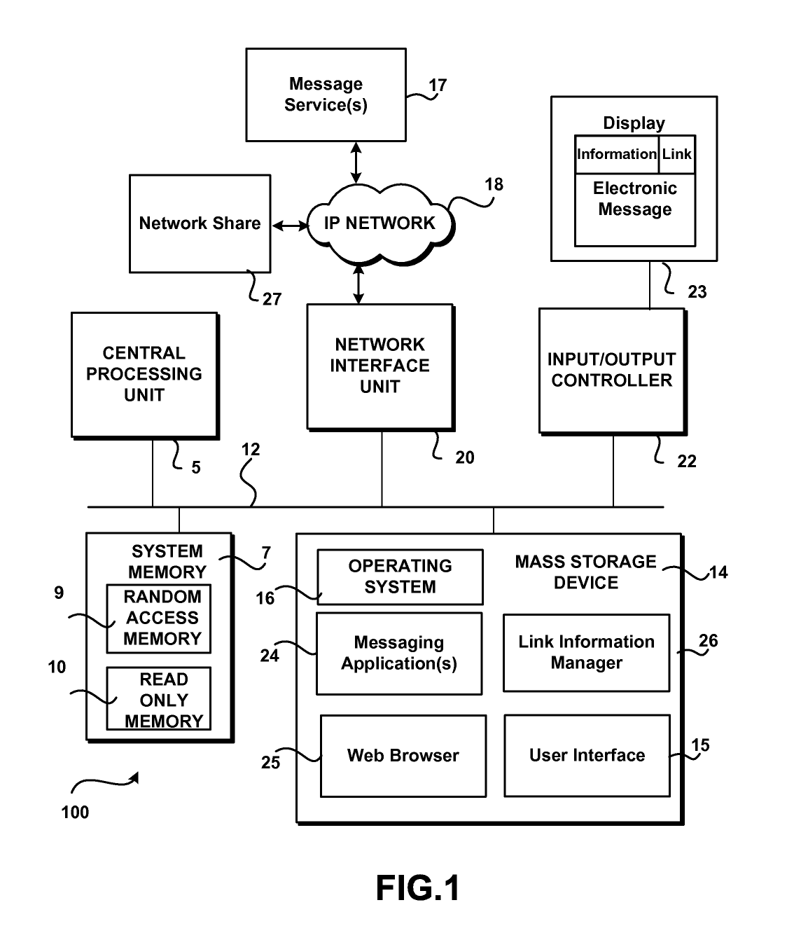

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, net book, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, messaging application(s) 24, Web browser 25, and link information manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to a display screen 23, a printer, or other type of output device.

As mentioned briefly above, a number of program modules and data files may be stored in the mass storage device 14 and RAM 9 of the computer 100, including an operating system 16 suitable for controlling the operation of a computer, such as the WINDOWS PHONE 7®, WINDOWS 7®, or WINDOWS SERVER® operating system from MICROSOFT CORPORATION of Redmond, Wash. The mass storage device 14 and RAM 9 may also store one or more program modules. In particular, the mass storage device 14 and the RAM 9 may store one or more application programs, including one or more messaging application(s) 24 and Web browser 25.

A user interface 15 is used by a user to interact with applications and documents. Messaging application(s) 24 may be one or more different messaging applications. For example, computing device 100 may include an email application, an Instant Messaging (IM) application, an SMS, MMS application, a real-time information network (e.g. Twitter® interface), a social networking application, and the like. According to an embodiment, messaging application 24 is an email application, such as MICROSOFT OUTLOOK®. The messaging application(s) may be client based and/or web based. For example, a network based message service 17 may be used, such as: MICROSOFT WINDOWS LIVE or some other network based email and messaging service.

Network share 27 is configured to store content (e.g. documents, spreadsheet, Web content, and the like) that are accessible to one or more users through IP network 18. For example, network share 27 may store content that is accessible by users located at one or more locations.

Link information manager 26 is configured to process links within messages and determine link information to present near the links within the message. The term “link” refers to an address that represents a location of content. For example, a link may be in the form of a Uniform Resource Locator (URL) that specifies a network location of where the content is stored. Selecting the link generally retrieves the content that is pointed to by the link. Link information manager 26 may be located externally from an application, e.g. messaging application 24, as shown or may be a part of an application. Further, all/some of the functionality provided by link information manager 26 may be located internally/externally from a messaging application.

Link information manager 26 is configured to determine and present link information near links within the message that describes activity relating to the linked content. Link information manager 26 automatically detects links to content that are placed within the body of a message and determines relevant link information relating the linked content. The link information is presented near the link within an electronic message such that a user may easily see the activity information relating to the linked content. The link information may include many different type of information. For example, the link information may include editing information for the linked content (e.g. editors, editing time, number of edits), who has/has not reviewed the linked content, linked content information (e.g. summary, permissions, type of content) and the like. The linked content may be a link to any type of content, such as word processing documents, spreadsheets, slides, websites and the like. Viewing the link information for the link provides a user with an indication of the activity of the linked content. More details regarding the link manager are disclosed below.

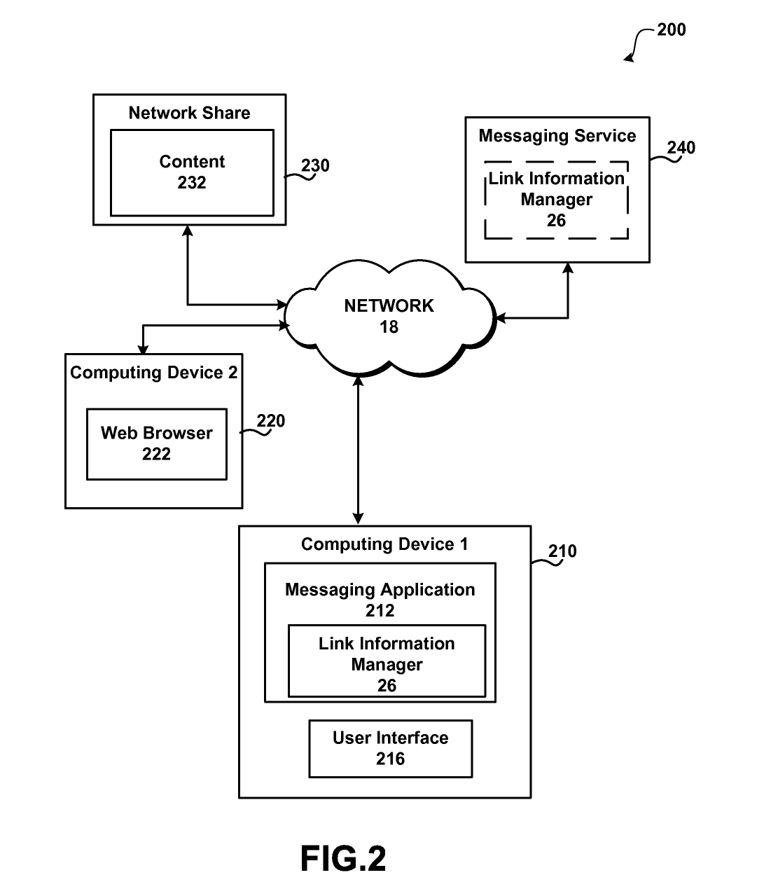

FIG. 2 shows a system for presenting link information near links within electronic messages. As illustrated, system 200 includes computing device 1 (210), computing device 2 (220), network share 230 and messaging service 240.

The computing devices may be any type of computing device that is configured to perform the operations relating to sending and receiving electronic messages that include links to content. For example, some of the computing devices may be: mobile computing devices (e.g. cellular phones, tablets, smart phones, laptops, and the like); desktop computing devices and servers. Some computing devices may be arranged to provide an online service (e.g. messaging service 240 that is configured for sending and receiving electronic messages), some may be arranged as data shares, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as computing device 1, computing device 2, network share 230 and messaging service 240.

Computing device 1 includes messaging application 212 and user interface 216. As illustrated, computing device 1 is used by a user to interact with electronic messages, content in a network share (e.g. content 232) and the like.

User interface (UI) 216 is used to interact with an application and content, such as messaging application 212 and content 232. One or more user interfaces of one or more types may be used to interact with the content. For example, UI 216 may include the use of a context menu, a menu within a menu bar, a menu item selected from a ribbon user interface, a graphical menu, and the like. Generally, UI 216 is configured such that a user may easily interact with content and electronic messages. For example, a user may simply select an option within UI 216 that creates new electronic messages that include links to content within the body of the electronic messages. UI 216 may also be used to display link information relating to a link within a message. Upon receipt of the message, the user views the link information for linked content that are associated with links that are included within the electronic message. The link information may be automatically displayed and/or manually displayed near the links. Some of the link information may be automatically displayed near the display of the link while a portion of the link information may be displayed in response to a user interaction. For example, a last editing time and editor along with a total number of edits may be automatically displayed near the link while a list of reviewers and/or summary information is displayed in response to a user hovering over the link, or performing some other action.

Messaging application 212 may be a client based application, such as an email application, an Instant Messaging Application, a social media application, and the like. Generally, messaging application 212 is used to send and receive electronic messages of one or more types. A network based messaging service 240 may be used in addition to messaging application 212 or instead of one or more of the different messaging applications. For example, a web interface may be used to access messaging service 240.

Messaging service 240 may be used to process electronic messages between one or more computing devices, such as computing device 1 and computing device 2. Messaging service 240 may be configured to process different message types, such as SMS, MMS, email, messages for social networks and the like. Messaging service 240 may be configured with the functionality of link information manager 26 and one or more message types may be used to communicate the electronic messages including links to content that are within the body of the electronic message.

Computing device 2 includes one or more applications, such as a web browser (222) that may be configured to access a messaging service, such as a web based email service and to interact with content. For example, a web browser may be used to access an electronic message through an email service and then access content 232 stored in network share 230.

One or more network shares (e.g. Network share 230) may be used to store content. The content may be any type of content that is linked within a message, such as word processing documents, spreadsheets, slides, website content and the like Network share 230 is accessible by the computing devices that interact with the content. The network share may be associated with an online service that supports online access/interaction with content.

Link information manager 26 is configured to detect any links to content that are included within a body of an electronic message and to obtain link information relating to the links. The links may be to any type of content, such as word processing documents, spreadsheets, slides, website content and the like. Generally, the link may be to any type of content that is accessible by a computing device. Any links to content that are detected within the body of the message are processed to determine the corresponding link information. The link information for the links may be detected before the message is sent and/or after the message is received. For example, upon receipt of the message, the link information for each of the links may be determined by accessing the linked content to determine activity information relating to the content. When the message is viewed by the user, the displayed link information allows a user to view activity information relating to the link.

According to an embodiment, the link information and the linked content is automatically downloaded before the user receiving the message views the message. The linked content and link information may be obtained before the message is sent and/or after the message is received by the user. For example, upon receipt of the message, the linked content and link information may be automatically downloaded and included with the message. All/some of the linked content/link information may be automatically downloaded. The linked content/link information may be automatically downloaded based on predetermined conditions, such as: the message is from a trusted sender, the size of the linked content is below a size threshold, the link is included within a reply message to the receiver of the message, the message originates from a specified source, and the like.

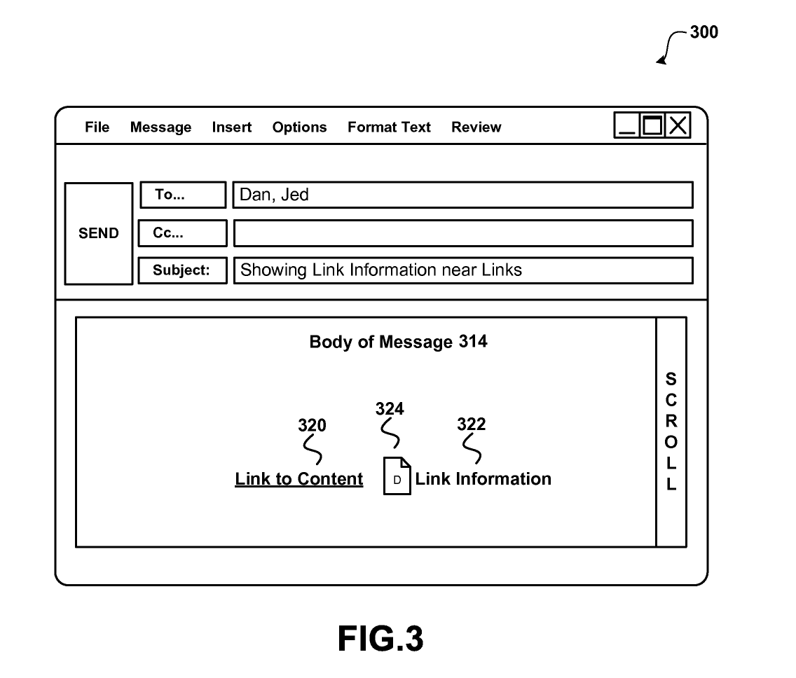

FIGS. 3-6 show exemplary electronic messages and link information for linked content. FIGS. 3-6 are for exemplary purpose and are not intended to be limiting.

FIG. 3 shows a display of an electronic message including a link within a body of an electronic message and corresponding link information. As illustrated, message 300 comprises a To: field, a Cc: field, a Subject field, and a body of the message 314 including a link to content 320, link information 322 and icon 324. More or fewer fields may be included with the electronic message.

The electronic message may be accessed a number of ways. For example, a web browser may access an electronic mail service, an email application on a computing device may be configured to receive emails from one or more different services, and the like.

When electronic message 300 is created, one or more links, such as link to content 320, is included within the body of the message. The links may be to any type of content, such as word processing documents, spreadsheets, slides, websites and the like.

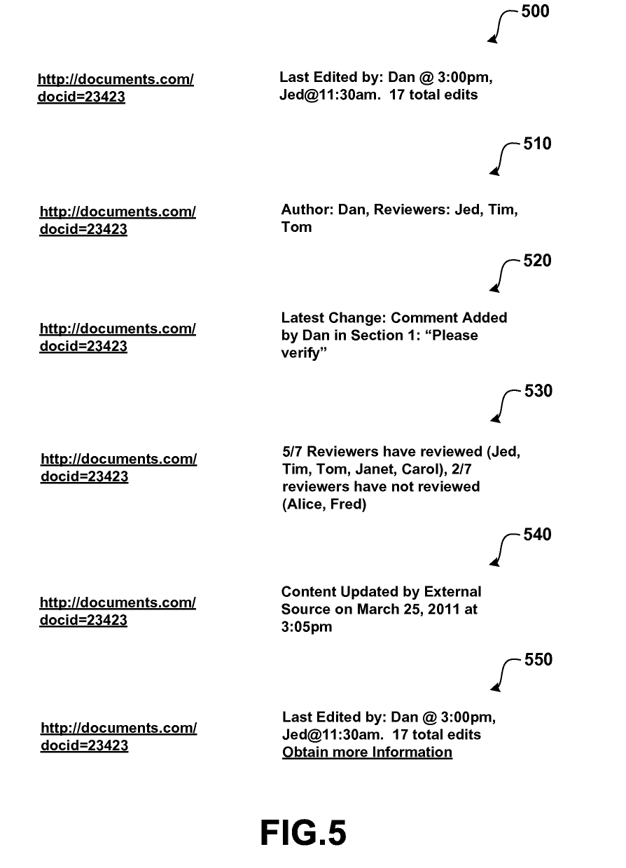

One or more links to content that are included within the body of the message may include link information that is automatically/manually displayed such that when a user receiving the message accesses the message, link information for one or more of the links is viewable near the link. In this way, the user can readily view activity information and other information relating to the linked content. The link information may contain a variety of different information. For example, the link information may include editing information for the linked content (e.g. editors, editing time, number of edits), who has/has not reviewed the linked content, linked content information (e g summary, permissions, type of content) and the like (See FIG. 5 and related discussion for exemplary link information).

The link information may be presented in different locations relative to the link. Generally, the link information is located near the link such that the display of the link and the link information are viewable within a same display. For example, the link information 322 may be located to the right of link 320, above link 320, below link 320 or to the left of link 320.

A graphical indicator 324, such as an icon, may be displayed with the link information 322. The graphical indicator may be selected to indicate a type of the content and/or other characteristics/activity relating to the linked content. For example, a document icon may be used to show the content is a document, a web icon may be used for web content, a spreadsheet icon may be used for spreadsheets, a picture icon may be used for pictures, a message icon may be used for messages, and the like. Other indicators may also be used to show other information (e.g. an indicator to show that the linked content has been downloaded).

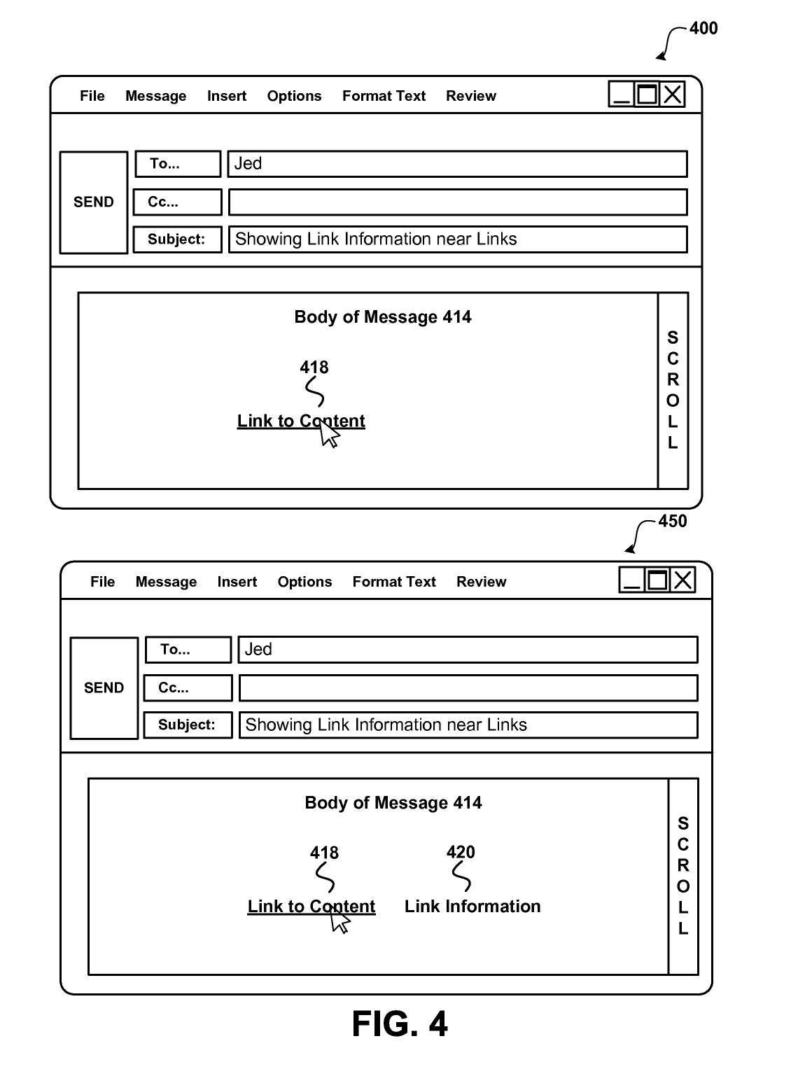

FIG. 4 shows a display of an electronic message before and after a user action is performed to display link information for a link. As illustrated, message 400 shows a link 418 to content within the body of the message 414. As discussed, link information may be displayed automatically/manually. In the current example, a user positions a cursor over the link 418 in order to request link information to be displayed for link 418. Other methods to request link information may be performed. For example, a context menu may be presented that includes various options for presenting link information (e.g. reviewer information, edit information, content information, and the like).

In response to the user selection (e.g. cursor hovering over link 418), link information 420 is displayed as illustrated in display 450. Link information may be displayed for a predetermined period of time and/or while the cursor is located over the link. For example, the link information may be displayed as long as link 418 is within view.

FIG. 5 shows exemplary link information that may be displayed near links within an electronic message.

Link information 500 shows information that shows who last edited the document along with a time of the edit, a previous editor and a time, and a number of total edits made to the linked content. More or less editing information and/or other information may be included within the display of the link information.

Link information 510 shows the author of the linked content and the name of the reviewers assigned to review the document.

Link information 520 shows a latest change made to the document. In the current example, the latest change was a comment added by Dan. Other types of changes may be shown (e.g. permission changes, content changes, and the like).

Link information 530 shows a current status of the review of the linked content. In the current example, a number of reviewers that have already reviewed the document is displayed along with their names and a number of reviewers who have not reviewed the linked content along with their names is displayed.

Link information 540 shows a status update. In the current example, the status update indicates that the content was updated by an external source at a specific time. For example, the content may be a web page that was updated. Other status updates may also be shown within the link information (e.g. a specified condition is met).

Link information 550 shows the link information shown in example 500 along with a link to obtain more information. Selecting the “Obtain more Information” link may provide an additional display of link information that is predetermined and/or specified upon selecting the link.

According to an embodiment, a default set of link information is selected to determine the link information to initially display. A default set of link information may be selected for each content type (e.g. document, web content) or a common default set of link information may be selected and applied to each of the different content types.

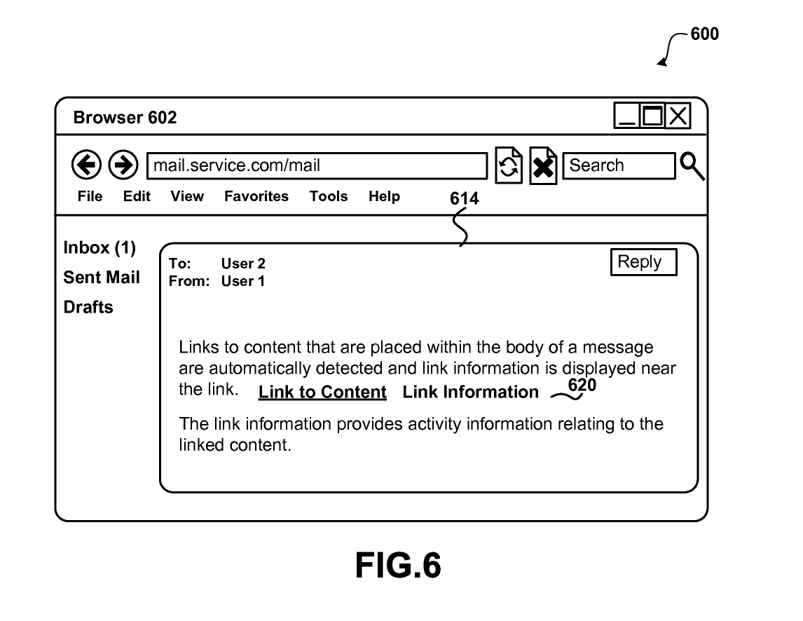

FIG. 6 shows a display of an electronic message within a Web browser including a link to content and link information within a body of an electronic message. As illustrated, Web browser 602 shows message 614 that includes a link to content and corresponding link information 620.

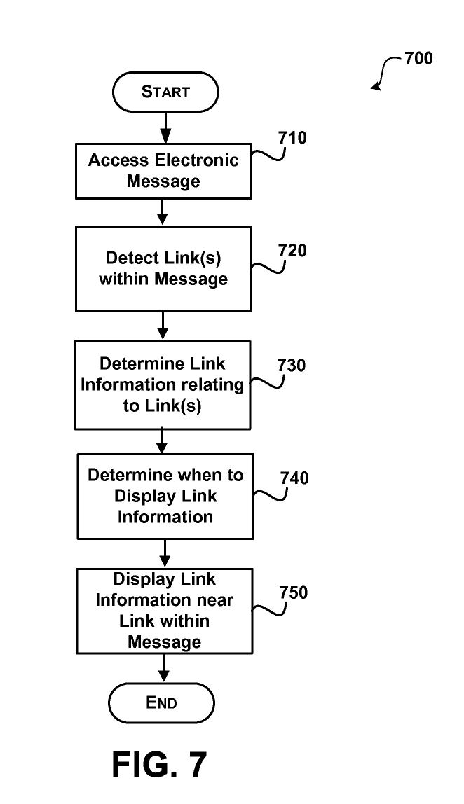

FIG. 7 shows an illustrative process for presenting link information near links within electronic messages. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start block, process 700 moves to operation 710, where the electronic message is accessed. The electronic message may be any electronic message that includes a link within the body of the message. According to an embodiment, the electronic messages are email messages. Other messages may also include links, such as SMS, MMS, Instant Messages, social network messages, and the like.

Flowing to operation 720, any links that are contained within the body of the electronic message are detected. The detection may occur before the message is sent and/or after the message is sent. For example, when a message is received, the message may be automatically parsed to detect the links that are included within the body of the message. The links may be contained anywhere within a thread of the electronic message (e.g. within a first reply to a message, a third reply and the original message).

Moving to operation 730, the link information for each of the links is automatically determined. All/portion of the links may include link information that may be obtained. For example, a link to content may be to a document that includes document information such as edit times, reviewers, summary information and the like that may be accessed. Some linked content may include less information (e.g. a last update time). The link information may be obtained before the message is sent and/or after the message is received by the user. For example, upon receipt of the message, the link information may be automatically downloaded and included with the display message.

Transitioning to operation 740, a determination is made as to when to display the link information. The link information may be displayed automatically/manually. Further, a portion of the link information may be displayed automatically while another portion of the link information may be displayed in response to a manual user interaction (e.g. selecting a menu option, selecting a link). According to an embodiment, editing information is automatically displayed that includes a last editor and time and a number of edits. Other link information may be displayed. For example, a last number of edits may be displayed, a summary of the editing information, and the like.

Flowing to operation 750, the electronic message is displayed with the link information. When a user views the message, the link information is displayed near the link such that current information regarding the linked content is readily viewable. The link information may also be displayed within a popup window or within another portion of the message window (e.g. an information display portion of the message window). A graphical indicator, such as an icon, may also be displayed with the link information to indicate a type of the content and/or other information relating to the linked content.

The process then flows to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for presenting link information near a link within an electronic message, comprising:
detecting a link to content within an electronic message;
determining link information relating to the link that is externally located from the link that describes activity information relating to the linked content; and
displaying the link information near a display of the link within the electronic message.

2. The method of claim 1, wherein determining the link information comprises determining editing information of the linked content.

3. The method of claim 2, wherein determining the editing information comprises determining: a last editing time, a number of edits to the linked content within a predetermined period of time, a number of editors, and a name of each of the editors.

4. The method of claim 1, wherein determining the link information comprises determining a summary of the linked content comprising a type of the linked content.

5. The method of claim 1, wherein displaying the link information near the display of the link within the electronic message, comprises displaying a last edit time of the linked content and a name of the last editor.

6. The method of claim 1, wherein displaying the link information near the display of the link within the electronic message, comprises determining when a pointing device is hovering over the link and displaying the link information in response to the hovering.

7. The method of claim 1, wherein determining the link information comprises determining reviewers assigned to review the linked content and the reviewers who have reviewed the linked content and the reviewers who have not reviewed the linked content.

8. The method of claim 7, wherein displaying the link information near the display of the link within the electronic message, comprises displaying each reviewer name.

9. The method of claim 1, wherein determining the link information occurs after the message is received and before the message is displayed.

10. A computer-readable storage medium storing computer-executable instructions for presenting link information for links within an electronic message, comprising:
detecting a link to content within an electronic message;
determining link information relating to the link that is externally located from the link that describes activity information relating to the linked content, wherein the activity information includes editing information for the linked content; and
displaying the link information near a display of the link within the electronic message.

11. The computer-readable storage medium of claim 10, wherein determining the link information including the editing information comprises determining: an editing time and a number of edits to the linked content.

12. The computer-readable storage medium of claim 10, wherein determining the link information comprises determining a summary of the linked content comprising a type of the linked content and displaying an icon representing the type of the linked content with the link information.

13. The computer-readable storage medium of claim 10, wherein displaying the link information near the display of the link within the electronic message, comprises displaying a last edit time of the linked content and a name of the last editor.

14. The computer-readable storage medium of claim 10, wherein displaying the link information near the display of the link within the electronic message, comprises determining when a pointing device is hovering over the link and displaying the link information in response to the hovering.

15. The computer-readable storage medium of claim 10, wherein determining the link information comprises determining reviewers assigned to review the linked content and the reviewers who have reviewed the linked content and the reviewers who have not reviewed the linked content.

16. The computer-readable storage medium of claim 10, wherein determining the link information occurs after the message is received and before the message is displayed.

17. A system for presenting link information for links within an electronic message, comprising:
a network connection that is configured to connect to a network;
a processor, memory, and a computer-readable storage medium;
an operating environment stored on the computer-readable storage medium and executing on the processor;
a messaging application; and
a link information manager operating in conjunction with the messaging application that is configured to perform actions comprising:
detecting a link to content within an electronic message;
determining link information relating to the link that is externally located from the link that describes activity information relating to the linked content, wherein the activity information includes editing information for the linked content; and
displaying the link information near a display of the link within the electronic message.

18. The system of claim 17, wherein displaying the link information near the display of the link within the electronic message, comprises displaying a last edit time of the linked content and a name of the last editor and a number of total edits.

19. The system of claim 17, wherein determining the link information comprises determining reviewing information comprising reviewers assigned to review the linked content and the reviewers who have reviewed the linked content and the reviewers who have not reviewed the linked content and displaying the reviewing information.

20. The system of claim 17, further comprising determining when a request is received to display additional link information relating to the link.
